(19) United States
(12) Patent Application Publication
(10) Pub. No.: US 2006/0033386 A1
(43) Pub. Date: Feb. 16, 2006

(54) Linear motor for use in machine tool

(75) Inventors: Masanobu Uchida, Takefu-shi (JP); Koji Miyata, Takefu-shi (JP); Ken Ohashi, Takefu-shi (JP)

Correspondence Address: MYERS BIGEL SIBLEY & SAJOVEC, PO BOX 37428, RALEIGH, NC, 27627, US

(73) Assignee: Shin-Etsu Chemical Co., Ltd.

(21) Appl. No.: 11/200,784

(22) Filed: Aug. 10, 2005

(30) Foreign Application Priority Data
Aug. 13, 2004 (JP) 2004-235807

(51) Int. Cl. H02K 41/00

(52) U.S. Cl. 310/12

(57) ABSTRACT

Provided is a linear motor for use in a machine tool having high positioning accuracy. A linear motor 10 for use in a machine tool comprises: a stator 13 comprising a plurality of permanent magnets 12 which are arranged on both faces of a plate-like yoke 11 at equal intervals in a direction in which a mover moves, wherein the permanent magnets have the same shape, are magnetized in a direction perpendicular to the faces of the yoke 11, and an adjacent permanent magnet 12 has a different magnetization orientation; and a pair of movers 16 comprising armature cores 14 wound with armature coils 15 which are opposed to rows of the permanent magnets 12 provided on both the faces of the plate-like yoke 11 such that central axes of the armature cores 15 are parallel to the magnetization direction of the permanent magnets 12. A surface treatment film can be preferably formed on an exposed surface of the permanent magnets after the plurality of permanent magnets 12 is arranged on both the faces of the plate-like yoke 11.

### RELATED APPLICATION

This application claims priority from Japanese Patent Application No. 2004-235807; filed Aug. 13, 2004, the disclosure of which is incorporated by reference herein in its entirety.

### BACKGROUND OF THE INVENTION

1. Field of the Invention

The present invention relates to a linear motor for use in a machine tool. In particular, the present invention relates to a linear motor that is used for driving devices in machine tools such as cutting devices, milling machines, machining centers, and laser processing machines and that has permanent magnet type stators.

2. Description of the Related Art

A laser processing machine conventionally has been used widely as a device for processing semiconductor workpieces and the like. FIG. 5 is a conceptual diagram showing an example of a laser processing machine according to prior art. A laser processing machine shown in the drawing comprises a table 122 above a frame 121, and a workpiece (not shown) to be processed on the table 122. Moreover, an X-axis driving device 123 that can move in the X-axis direction in a coordinate plane parallel to the face of the workpiece to be processed is mounted above the frame 121. Furthermore, a Y-axis driving device 124 that can move in the Y-axis direction is mounted to the driving device 123 via a fitting, a Z-axis driving device 125 that can move in the Z-axis direction is mounted to the Y-axis driving device 124, and a torch 126 for emitting a laser beam is mounted to the Z-axis driving device 125. In FIG. 5, the wiring of the driving devices, a control device, and components for delivering the laser beam are omitted.

In the laser processing machine having such a configuration, the X-axis driving device 123 and the Y-axis driving device 124 are controlled by the control device (not shown) to cut the workpiece to a desired shape while exposing the workpiece to the laser beam from the torch 126 mounted in the tip portion. Moreover, in order to focus the laser beam, the distance between the torch 126 and the workpiece is controlled using the driving device 125 in the Z-axis direction. In a conventional laser processing machine having such a configuration, driving devices comprising a rotary servomotor and a ball screw have been used.

However, regarding the above-described laser processing machine using a rotary servomotor, there has been a limitation in high-speed processing, and the limit has been about 20 m/min. at fast forward speed. Furthermore, in the cases of workpieces having a long length of more than 3 m, there has been a problem in that processing accuracy is reduced due to, for example, bending of the ball screw. Thus, replacement of the driving device part by a linear motor has been considered.

A linear motor comprises a stator in which a plurality of permanent magnets are mounted on a plate-like yoke such as an iron plate at an equal pitch, the permanent magnets being magnetized in a direction perpendicular to the face of the yoke, such that the permanent magnets have alternate magnetization orientations; and movers in which armature coils are wound around armature cores (magnetic cores) that are made of a magnetic material and that are opposed to the row of the permanent magnets. Since a machine tool needs a large thrust, such a linear motor is preferably used. In the linear motor, position control, speed control, and the like are performed by passing a current suited to a position of these armature coils through the armature coils, and the position is determined on the assumption that the permanent magnets are arranged at an equal pitch in a row. Thus, if there is a pitch error, it is difficult to perform positioning at a high speed with high accuracy, and there may be a case where advantages of the linear motor cannot be provided sufficiently. It should be noted that the pitch (also referred to as “magnet pitch”) is the sum of the width of each of the permanent magnets and the gap distance between adjacent permanent magnets in a direction in which the mover moves.

Japanese Patent Application Unexamined Publication No. 2002-281729 discloses a linear motor, in which magnets and spacers are polished collectively, so that members having the same shape and the same size can be obtained, respectively, and thus precise feeding can be achieved because the individual difference is small.

### SUMMARY OF THE INVENTION

The magnets used in the linear motor may preferably include a permanent magnet such as Nd—Fe—B from the viewpoint of magnet properties. However, since Nd—Fe—B magnets are easily oxidized depending on their additional element, these magnets are generally subjected to a surface treatment for rust prevention. The thickness of a film of the rust preventive surface treatment formed on the surface of the magnet can be varied depending on the method of the surface treatment. In some cases, a film thickness variation as large as in the order of 100 μm may arise between the magnets. In this case, even when magnets and spacers having the same shape and the same size are prepared using the processing method disclosed in Japanese Patent Application Unexamined Publication No. 2002-281729, there is a variation in the size at the time when the magnets and the spacers are actually incorporated into a stator, and thus equal magnet pitches in the magnet row cannot be obtained stably. Under such a situation, an individual difference occurs in linear motors and machine tools equipped with the linear motors, and thus there has been a problem in that high-speed and high-accuracy positioning cannot be performed with the same control parameters. The present invention is directed to solve the above-described problem.

That is, the present invention provides a linear motor for use in a machine tool, comprising:

a stator comprising a plurality of permanent magnets which are arranged on both faces of a plate-like yoke at equal intervals in a direction in which a mover moves, wherein the permanent magnets have the same shape, are magnetized in a direction perpendicular to the faces of the yoke, and an adjacent permanent magnet has a different magnetization orientation; and

a pair of movers comprising armature cores wound with armature coils which are opposed to rows of the permanent magnets provided on the both faces of the plate-like yoke, such that central axes of the armature cores are parallel to the magnetization direction of the permanent magnets,

wherein the plurality of permanent magnets comprise on an exposed surface of the permanent magnets a surface treatment film that has been formed after the plurality of permanent magnets have been arranged on the both faces of the plate-like yoke.

According to another aspect, the present invention provides a method for manufacturing a stator of a linear motor for use in a machine tool, comprising:

a step of arranging a plurality of permanent magnets having the same shape on both faces of a plate-like yoke at equal intervals in a direction in which a mover moves; and

a step of forming a surface treatment film on an exposed surface of the arranged permanent magnets.

According to the present invention, it is possible with the above-described configuration to provide a linear motor for use in a machine tool, wherein the linear motor comprises a stator whose magnet rows have equal magnet pitches, can achieve high productivity at low cost, and is capable of feeding and positioning at a high speed. In such a linear motor for use in a machine tool, a magnet pitch error, which occurs in a stator obtained by forming a film on magnets by a surface treatment and by subsequently arranging on the yoke the magnets on which the surface treatment film has been formed, and which occurs owing to a variation in the thickness of the formed film, can be avoided. Moreover, by employing the above configuration, it is possible to prevent a dent or a defect due to a collision with other articles when disposing and installing the stator in a machine tool, and to provide a protection for the stator when the linear motor is transported.

### BRIEF DESCRIPTION OF THE DRAWINGS

FIG. 1 is a cross-sectional view showing a linear motor of the present invention.

FIG. 2 is a conceptual diagram schematically showing components of a stator.

FIG. 3 is a conceptual diagram schematically showing the stator that has been assembled.

FIG. 4 is a graph showing a relationship between a cogging force and a moving distance of a mover for the linear motors of Example and of Comparative Example.

FIG. 5 is a diagram conceptually showing a machine tool comprising a driving device.

In the drawings, reference numeral 10 denotes a linear motor, 11 a plate-like yoke, 12 a permanent magnet, 13 a stator, 14 an armature core, 15 an armature coil, 16 a mover, 17 a magnet row, 18 a plate, 121 a frame, 122 a table, 123 an X-axis direction driving device, 124 a Y-axis direction driving device, 125 a Z-axis direction driving device, and 126 a torch.

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

### DETAILED DESCRIPTION OF THE PREFERRED EMBODIMENT

Hereinafter, the present invention will be described in greater detail with reference to the drawings. In the drawings, the same members bear the same numerals.

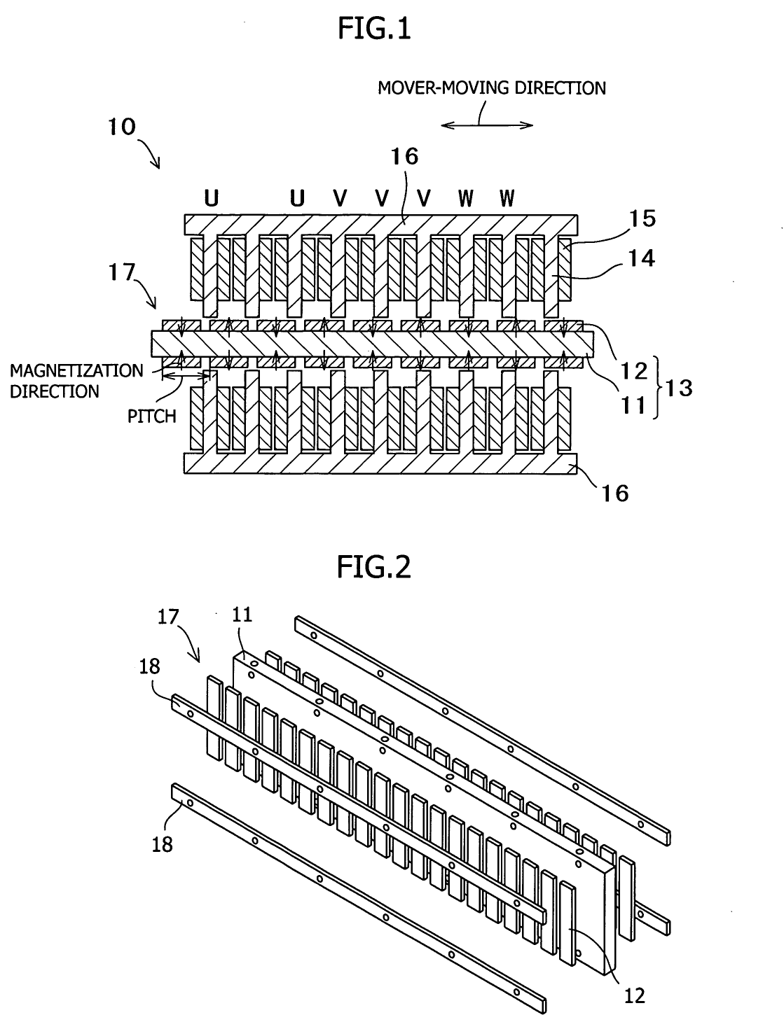

FIG. 1 is a cross-sectional view of a linear motor 10 according to an embodiment of the present invention, taken along a plane that is parallel to a direction in which a mover moves and that is perpendicular to faces of a yoke to which permanent magnets are fixed. The linear motor 10 comprises a stator 13 comprising a plate-like yoke 11 and a plurality of permanent magnets 12; and movers 16 comprising armature cores 14 and armature coils 15.

In the stator 13 shown in the drawing, the plurality of permanent magnets 12 are arranged on one face of the plate-like yoke 11 with equal pitches along the longitudinal direction of the yoke 11, forming a magnet row 17.

The plate-like yoke 11 is a plate-like member whose longitudinal direction corresponds to the moving direction of the movers. As the material of the plate-like yoke 11, particularly common magnetic materials can be used. Examples of such materials may include, but not limited to, low carbon steel and a silicon steel sheet. It should be noted that the yoke 11 may be in a one-piece form or a form in which the yoke has been divided into separate parts. In the case of the form in which the yoke has been divided into separate parts, the separate parts can be assembled at a stage of incorporating the linear motor into a machine tool.

Each of the plurality of permanent magnets 12 may be a plate-like member having the same shape and the same size. The material of the permanent magnets 12 may include, for example, rare earth permanent magnets such as Nd- and Sm-based magnets, ferrite permanent magnets, and alnico permanent magnets. According to the present invention, a Nd—Fe—B based magnet, which is particularly easily oxidized, may be more effective. In particular, it may be preferable to use magnets obtained by powder metallurgy and a quenching method so as to have a desired composition.

The permanent magnets 12 are usually fixed to the plate-like yoke 11 via an adhesive or the like. The permanent magnets 12 are magnetized in a direction perpendicular to the face of the plate-like yoke 11 to which the magnets are fixed, and adjacent permanent magnets 12 have alternate magnetization orientations. In FIG. 1, the magnetization orientations of the permanent magnets 12 are shown by arrows. The magnet pitch can be determined as appropriate according to the number of armature core teeth of the mover and the number of poles of the permanent magnets, and furthermore the size and the shape of the permanent magnets.

Furthermore, the permanent magnets 12 also are disposed on the other face of the plate-like yoke 11 in the same manner. At this time, the magnet rows 17 on both the faces of the yoke 11 are opposed to each other so that the magnet rows overlap each other with the yoke 11 sandwiched therebetween, and two permanent magnets 12 opposed to each other are magnetized in opposite orientations.

In the magnet rows 17 disposed as described above, a surface treatment film is formed on an exposed surface of the permanent magnets 12. The thickness of the surface treatment film may be preferably not more than 1 mm, and more preferably more than 0 mm and not more than 0.5 mm. When the thickness of the formed film is more than 1 mm, then the film may overlap with the gap between the permanent magnets 12 and the movers 16 so that the operation of the movers 16 may be affected. Moreover, control of the film thickness may be hindered.

The surface treatment film can comprise a heat resistance resin including a natural resin or a synthetic resin such as silicone resin, epoxy resin, urethane resin, acrylic resin, polyimide resin or enamel.

The stator 13 may comprise a plate. FIG. 2 schematically shows members constituting the stator comprising plates. The plates 18 can be attached above the faces of the yoke 11 to which the permanent magnets 12 are fixed so as to be parallel to the magnet rows 17. By the plates 18, displacement of the fixing position of the permanent magnets 12 in a direction perpendicular to the longitudinal direction of the yoke can be prevented. In an embodiment shown in FIG. 2, two magnet-holding plates 18 are disposed respectively in contact with faces in the width direction of the permanent magnets 12 so that the magnet row 17 is interposed between them, and are fixed with, for example, a screw, a bolt, or a heat resistant resin material such as epoxy resin.

The movers 16 comprise the armature cores 14 having a plurality of teeth wound with the armature coils 15. In the movers 16, a plurality of armature coils 15 are provided and arranged such that the central axes of the coils 15 are parallel to each other along the moving direction of the movers. The armature cores 14 can comprise the same magnetic material as the above-described plate-like yoke 11. As for the armature coils 15, for example, a copper wire can be used.

Moreover, the movers 16 are disposed, with an air gap between the magnet rows 17 and them, such that the central axes of the plurality of armature coils 15 are perpendicular to the faces of the above-described plate-like yoke 11 to which the magnet rows 17 are fixed, that is to say, the central axes are parallel to the magnetization direction of the magnets. The spacing between the magnet rows 17 and the movers 16 can be set to about 1 mm. It is noted that one each of the movers 16 can be disposed on each side of the stator 13.

With the linear motor 10 having such a configuration, accurate and high-speed positioning becomes possible when the linear motor is used for a moving mechanism of a laser processing machine.

Next, the linear motor 10 according to the present embodiment will be described from an aspect of the method for manufacturing the stator 13. The method for manufacturing the stator 13 of the linear motor 10 according to the present embodiment comprises a step of arranging the plurality of permanent magnets 12 on both faces of the plate-like yoke 11, the permanent magnets 12 having the same shape and being magnetized in a direction perpendicular to the faces of the yoke, at equal intervals in the moving direction of the movers 16, such that the adjacent-permanent magnets 12 have different magnetization orientations; and a step of forming a surface treatment film on an exposed surface of the arranged permanent magnets 12.

In the step of arranging, the permanent magnets 12 that have not been subjected to a surface treatment are laminated on the plate-like yoke 11 and fixed thereto. At this time, the permanent magnets are laminated such that the magnet pitches in the magnet rows are stably equal. For this purpose, for example, end faces of the permanent magnets 12 are aligned with a position for defining the magnet pitch on the plate-like yoke 11, using a position fixture or the like, so that the distance between adjacent magnets is constant without deviation, and thus it is possible to perform positioning with high accuracy. Moreover, positioning of the permanent magnets 12 also can be performed by a method using a spacer, a method using a groove, or any other methods. Such an accurate positioning method can be made possible by directly laminating the permanent magnets 12 on the plate-like yoke 11 wherein the permanent magnets 12 have not been subjected to a surface treatment. In order to fix the permanent magnets 12 to the plate-like yoke 11, for example, an adhesive can be used.

Preferably, an optional step of attaching plates for holding the magnets on the outer side of the magnet rows 17 also can be carried out after the step of arranging. The plates can be attached by fixing the plates to the-plate-like yoke 11 with, for example, a screw, a bolt, or a heat resistant resin material such as an epoxy resin.

In the step of forming the surface treatment film, a surface treatment material is applied to an exposed surface of the permanent magnets 12 that already have been positioned and fixed to the plate-like yoke 11. More specifically, this step can be carried out by soaking a brush, a waste, or the like with an appropriate surface treatment material and applying the surface treatment material to the exposed surface of the permanent magnets 12. Alternatively, it is also possible to coat the exposed surface of the permanent magnets 12 with the surface treatment material using a spatula, a roll, or the like. Moreover, the surface treatment film may be formed on the permanent magnets 12 by dipping the permanent magnets 12 that have not been subjected to a surface treatment, together with the plate-like yoke 11 to which the permanent magnets are fixed, into a solution of the surface treatment material. In the formation of the surface treatment film, coating can be performed on only one side of the yoke 11 at a time, or on both faces (both sides) of the yoke 11 at the same time. In the case of the stator comprising the plates, coating is performed after arranging the permanent magnets 12 on the yoke 11 and securing the plates. Consequently, faces of the permanent magnets 12 that have been fixed to the plates may not be exposed and thus may not be subjected to the surface treatment.

The surface treatment material may be of aqueous type or of solvent type, but it may be preferable to be a material which does not contain metal. Examples of the material may include a natural resin and a synthetic resin such as silicone resin, epoxy resin, urethane resin, acrylic resin, polyimide resin and enamel. More specifically, a silicone varnish (KR255, made by Shin-Etsu Chemical Co., Ltd.), a urethane coating (POR-15, made by MANNNA TECH), an enamel paint (Hipon, made by Nippon Paint Co., Ltd.), an epoxy paint, rosin, and the like can be used, but the present invention is not limited thereto. Furthermore, it is also possible to use a mineral grease. Optional drying may be performed, depending on the type of surface treatment material. Consequently, the surface treatment film can be formed on the exposed surface of the permanent magnets 12.

Coating may be performed such that the thickness of the surface treatment material in the solid state is preferably not more than 1 mm, further preferably more than 0 mm and not more than 0.5 mm. Moreover, it is also possible to heat the surface treatment material coated, if necessary.

With such a method for manufacturing the stator 13, it is possible to form a magnet row having equal magnet pitches while the difference in the thickness of the surface treatment film between the magnets does not affect the magnet pitches. Thus, it is possible to manufacture a linear motor having high positioning accuracy.

### EXAMPLE 1

First, Nd—Fe—B based sintered permanent magnets 12 (length 100 mm×width 18 mm×thickness 5 mm) that had not been subjected to a surface treatment were laminated on both faces of an iron yoke 11 (length 550 mm×width 116 mm×thickness 19 mm) of a material S50C, via a special polymer adhesive having the applied thickness of 20 μm. At this time, the permanent magnets 12 were arranged with equal pitches of 25 mm along the moving direction of movers such that the permanent magnets have alternate magnetic poles. The plates for holding the magnets were secured to both ends of the permanent magnets. Next, a silicone varnish (KR255, made by Shin-Etsu Chemical Co., Ltd.) was applied to an exposed surface of the secured permanent magnets 12 using a brush, thereby forming a treatment film having a thickness of about 200 μm. Then, movers 16 comprising armature cores 14 of a magnetic material wound with copper wires were placed so as to be opposed to the permanent magnets 12, keeping a spacing of about 1 mm between the movers and the permanent magnets. Thus, a linear motor 10 was fabricated.

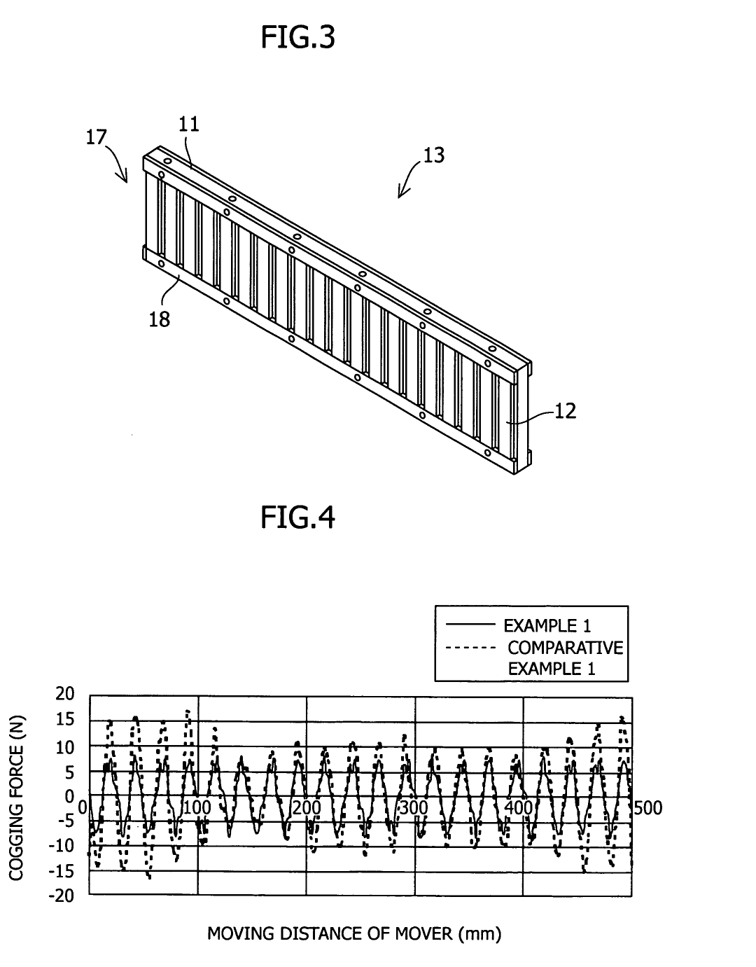

FIG. 2 schematically shows an assembly of the stator 13 of the linear motor 10 fabricated in Example 1. The stator 13 comprised the plate-like yoke 11, the magnet rows 17 formed on both faces of the yoke, and the plates 18 for holding the magnets, the plates being parallel to the magnet rows 17 such that the magnet rows were interposed between the plates. Since the permanent magnets 12 used in Example 1 had not been subjected to a surface treatment, there was no need for giving consideration to a variation in the thickness of the formed film, and thus the plate-like yoke 11 having a strict dimensional tolerance could be fabricated. Furthermore, also when the permanent magnets 12 were mounted on the plate-like yoke 11, positioning could be performed with high accuracy simply by aligning the end faces of the permanent magnets 12 with a position for defining the magnet pitch. Moreover, FIG. 3 schematically shows a configuration of the stator 13 after the permanent magnets 12 were arranged on the surfaces of the yoke 11 and fixed thereto. The magnet rows 17 were interposed between two plates 18 that had been secured with a screw, so that displacement of the permanent magnets 12 in a direction perpendicular to the moving direction of the movers was prevented. In this state, a surface treatment was performed.

Rust prevention of the linear motor 10 that had been fabricated in Example 1 and that had been left in a room for three months was observed. It was found that the surface was in a good condition.

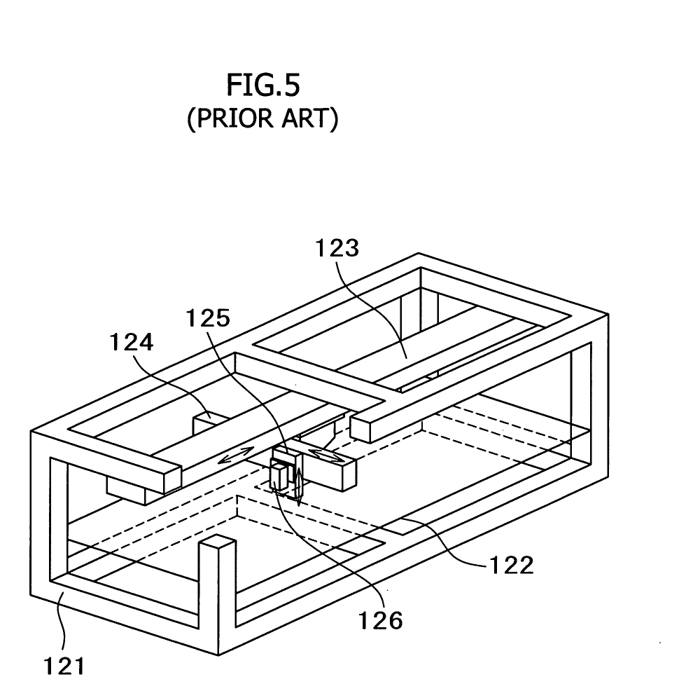

FIG. 4 shows the measurement results of the cogging torque of the linear motor 10. Measurement of the cogging torque was performed as follows: the linear motor 10 fabricated in Example 1 and a linear motor for evaluation were coupled via a 1 kN load cell, and the relationship between the position of the movers 16 and the thrust (the value indicated by the load cell) was measured by moving the linear motor for evaluation without passing a current through the linear motor 10 fabricated in Example 10 and by suspending it every 1 mm of the measurement pitch.

### COMPARATIVE EXAMPLE 1

As a comparative example, a linear motor was manufactured by attaching permanent magnets to the yoke wherein the permanent magnets had been subjected to a rust preventive treatment (epoxy coating having a thickness of 20 μm after curing) and by assembling. FIG. 4 also shows the cogging torque of the linear motor of Comparative Example 1. It should be noted that the same plate-like yoke, permanent magnets, and movers were used in Example 1 and Comparative Example 1.

The cogging force of a linear motor is a force that works periodically when a mover moves, in a direction into which the mover travels or in the opposite direction, and one cycle of the cogging force corresponds to the magnet pitch. The cogging force is a total of magnetic attraction forces that are generated between the magnets and the teeth of the armature cores. The magnetic attraction forces that are generated at the teeth inside the armature cores cancel each other out. However, the magnetic attraction forces that are generated at both ends of the armatures do not cancel each other out sufficiently, and thus appear as the cogging force having a cycle corresponding to the magnet pitch.

In FIG. 4, the difference between maximum value and minimum value of the cogging was 34 N in Comparative example 1, while it could be reduced even to 16 N in Example 1. Furthermore, pulsation of the waveform of the cogging due to an error in, for example, the magnet pitch also could be reduced, and this facilitated control of position and speed, and thus it was possible for the linear motor to perform high-speed positioning.

The present invention can be applied to a driving device in a machine tool such as cutting devices, milling machines, machining centers, and laser processing machines.

1. A linear motor for use in a machine tool, comprising:
a stator comprising a plurality of permanent magnets which are arranged on both faces of a plate-like yoke at equal intervals in a direction in which a mover moves, wherein the permanents magnets have the same shape, are magnetized in a direction perpendicular to the faces of the yoke, and an adjacent permanent magnet has a different magnetization orientation; and
a pair of movers comprising armature cores wound with armature coils which are opposed to rows of the permanent magnets provided on the both faces of the plate-like yoke, such that central axes of the armature cores are parallel to the magnetization direction of the permanent magnets,
wherein the plurality of permanent magnets comprise on an exposed surface of the permanent magnets a surface treatment film that has been formed after the plurality of permanent magnets has been arranged on the both faces of the plate-like yoke.

2. The linear motor for use in a machine tool according to claim 1, wherein said surface treatment film has not more than 1 mm of thickness.

3. A laser processing machine, comprising said linear motor according to claim 1, wherein the linear motor is used for a three-dimensional moving mechanism.

4. A method for manufacturing a stator of a linear motor for use in a machine tool, comprising:
a step of arranging a plurality of permanent magnets on both faces of a plate-like yoke at equal intervals in a direction in which a mover moves, wherein the permanent magnets have the same shape, are magnetized in a direction perpendicular to the faces of the yoke, and an adjacent permanent magnet has a different magnetization orientation; and
a step of forming a surface treatment film on an exposed surface of the arranged permanent magnets.
